(19) United States
(12) Patent Application Publication
(10) Pub. No.: US 2011/0247009 A1
(43) Pub. Date: Oct. 6, 2011

(54) DISTRIBUTING EVENTS BETWEEN AN INTEGRATED DEVELOPMENT ENVIRONMENT PROCESS AND ANOTHER PROCESS

(75) Inventors: Ken Dietrich, Glendale, AZ (US); Gary Fox, Glendale, AZ (US)

(73) Assignee: HONEYWELL INTERNATIONAL INC., Morristown, NJ (US)

(21) Appl. No.: 12/753,596

(22) Filed: Apr. 2, 2010

(51) Int. Cl. G06F 9/46; G06F 3/00

(52) U.S. Cl. 719/313

(57) ABSTRACT

A method for inter-process communications between an integrated development environment (IDE) process and a separate process. The IDE process and separate process are communicably coupled using an inter-process communication module that provides inter-process call channels for transporting messages between the IDE process and separate process, and adds a transport layer comprising routing information to the messages. A caller performs an action that raises an event that includes a requested operation to the IDE process, where the requested operation is only supported by the separate process. The IDE process sends a command message to the separate process using a first call channel that includes information for performing the requested operation. The requested operation is performed by the separate process. A return message is then sent by the separate process using a second call channel to the IDE process.

### FIELD

Disclosed embodiments related to methods and systems for communicating between an integrated development environment (IDE) process and a process outside the IDE.

### BACKGROUND

Software developers generally use IDEs to edit, build, and debug software applications. An example of an IDE is MICROSOFT VISUAL STUDIO, which is a software development tool provided by MICROSOFT CORPORATION. IDEs provide a user interface that developers can use to develop software components and applications. IDEs generally include developer tools, such as a source code editor, a compiler and/or interpreter, a build-automation tool, and a debugger. IDEs may also include a version control system and other tools to simplify construction of a graphical user interface (“GUI”).

IDEs can have various containers for constituents of applications, such as image files, source code files, libraries, etc. As examples, IDEs can have solution and project containers. A solution container can contain, among other things, one or more project containers. The project containers can contain constituents of applications. The constituents of the applications can be “built” by the IDE's developer tools (e.g., compiler), such as by translating human-readable source code to machine-executable object code. Each project container can be said to be a different project type because it can provide support for a different programming language. Examples of programming languages are C#, C++, MICROSOFT VISUAL BASIC, and PERL. A project container (or simply, “a project”) is generally defined by a project file. The project file can indicate items associated with the project, such as various properties associated with the project, and files that define the components the project contains.

Developers employ IDEs to build software components, such as controls and add-ins. A control is generally a component that a software developer adds to a form to enable or enhance a user's interaction with the form. An add-in is a component that a user can add to an application (“host application”) to supplement the host application's functionality.

IDE's such as VISUAL STUDIO are thus extensible using add-ins. VISUAL STUDIO includes VISUAL STUDIO Extensibility (VSX) that identifies methods and interfaces that allow developers outside of MICROSOFT to customize the VISUAL STUDIO Environment. However, the standard extensibility implementation does not support the scenario where the VISUAL STUDIO project operates as a client and is controlled by a remote process server where events are passed/raised to the remote process server for processing. Another limitation of VISUAL STUDIO is the other process requires everything to be loaded thereto, and thus be contained on a single common node.

### SUMMARY

Disclosed embodiments describe inter-process communications between an IDE process in an IDE environment and a separate process that provides new ways to customize the IDE environment. The IDE process and separate process are communicably coupled using an inter-process communication module that provides inter-process call channels for transporting messages between the IDE process and separate process. The inter-process communication module adds a transport layer comprising routing information to the messages.

To initiate inter-process communications, a caller performs an action that raises an event that includes a requested operation to the IDE process, where the requested operation is only supported by the separate process. The IDE process sends a command message to the separate process using a first call channel that includes information for performing the requested operation. The requested operation is performed at the separate process. A return message is then sent by the separate process using a second call channel to the IDE process.

In one embodiment, the command message and return message can comprise standard XML data and the transport layer can comprise transport layer XML. The messages can be implemented in a single XML document.

In one particular application where the IDE is the VISUAL STUDIO Environment. In this particular application, disclosed embodiments address the above described deficiency of VSX that now allow developers outside of Microsoft to customize the VISUAL STUDIO Environment for scenarios where the VISUAL STUDIO VSX project is controlled by a separate process where events, methods, etc. are passed/raised by the to the VISUAL STUDIO process to the separate process for processing.

### BRIEF DESCRIPTION OF THE DRAWINGS

FIG. 1 is a flow chart showing steps in an exemplary method for inter-process communications between an IDE process and a separate process, according to a disclosed embodiment.

FIG. 2 illustrates a diagram of an exemplary system including an inter-process communication module having communication channels for passing events between an IDE and a separate process, where the separate process receives information from the IDE over an inter-process communication channel for performing a requested operation and performs a requested operation, according to a disclosed embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Disclosed embodiments describe inter-process communications that use communication channels to pass the events and methods with its corresponding information between an IDE process and a separate process, which can be on the same node or a separate (i.e., remote) node. In one particular embodiment the IDE process is a VISUAL STUDIO process and the separate process is a CUSTOM ALGORITHM BLOCK (CAB) process. In this embodiment, the CAB development environment is built upon MICROSOFT VISUAL STUDIO software.

When a user performs an action that raises an event in the IDE, the event is caught by the IDE project that is implemented in the IDE environment and then passes this information to the separate process using an inter-process communication channel. This implementation is different as compared than the standard MICROSOFT VSX implementation in that it is simple, can use documented interfaces and is simpler to implement. One advantage also provided is that the controlling separate process can be on a different node (PC) where the standard MICROSOFT VSX implementation requires everything to be contained on one single node (e.g., a PC).

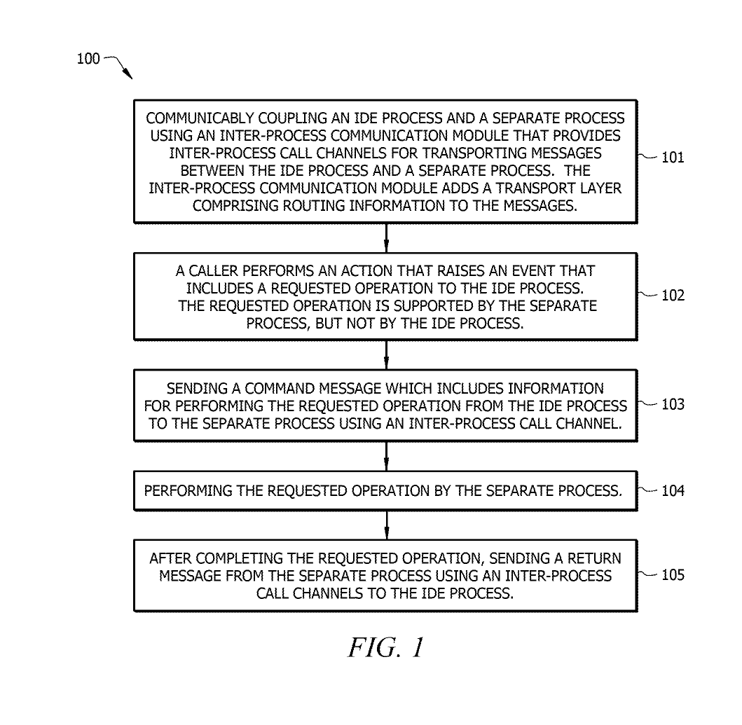

FIG. 1 is a flow chart showing steps in an exemplary method 100 for inter-process communications between an IDE process and a separate process, according to a disclosed embodiment. Step 101 comprises communicably coupling the IDE process and separate process using an inter-process communication module. The inter-process communication module provides inter-process call channels for transporting messages between the IDE process and separate process, and adds a transport layer comprising routing information and generally also security session identifier information to the messages. The inter-process communication module is implemented by program code (i.e., software) that can be run by a suitable processor.

In step 102, a caller performs an action that raises an event that includes a requested operation to the IDE process. The requested operation is supported by the separate process, but not by the IDE process. The caller's action can comprise clicking on a button or menu items in the IDE. Since the caller's action (e.g. pushing a button) is on the IDE process, the click event is captured or caught within the IDE process.

For example, in one embodiment the separate process includes a separate database for saving all data/files in a special (non-standard) format. Notably, IDE's such as VISUAL STUDIO only have a Save files routine which would save the data/files in the standard format on the separate database without a disclosed implementation, such as based on method 100.

Step 103 comprises sending a command message from the IDE process to the separate process using a first of the inter-process call channels. The command message includes information for performing the requested operation. This step thus passes the processing requested in step 102 to the separate process for processing, including the capability for special processing not provided by the IDE process. Step 104 comprises performing the requested operation by the separate process. In step 105, after completing the requested operation, a return message is sent from the separate process using a second of the inter-process call channels to the IDE process.

The separate process can be master controlling process and thus act as a server side process. The command message and return message comprise XML data and the transport layer can comprise transport layer XML. Although XML is not the only data format that can be used with disclosed embodiments, XML is a de-facto standard for providing a robust message passing mechanism that supports a diverse data content. XML also makes it easy to pass a single data format between processes that encompass widely diverse data content, so that a single string of XML data can represent all of the routing and data content that is generally needed to support the functionality for disclosed embodiments.

The transport layer XML can encapsulate an XML message layer, wherein a content of the XML message layer can (i) move events between the IDE process and the separate process, and (ii) transfer commands to be performed in the separate process for the command message. The commands and events can be encapsulated in a single XML document. The content can also provide information to the inter-process communication module as to which of the events after completion are to be reported to the IDE process, and which of the events are to be reported to the separate process.

The command message and return message can both comprise asynchronous message calls. Use of asynchronous message passing results in avoiding “freezing” the requesting process while the request is being processed and to handle events that occur at indeterminate times. Without asynchronous messages, any actions performed on the IDE would be ignored while processing requests in the separate process (e.g., CABOCX process). As known in the art, CABOCX is an ActiveX control. Performing asynchronous calls will also allow the user to perform additional tasks (e.g., editing the code) while requests are being processed in the separate process.

In one particular embodiment the IDE process comprises a VISUAL STUDIO process and the separate process comprises a CABOCX process. The CABOCX process can be operable to create and manage at least one control strategy, such as part of the HONEYWELL CONTROL BUILDER.

In one embodiment the IDE process and separate process are connected to a common node. In this embodiment the communications over the inter-process call channels can be over an Interprocess Communication (IPC) interface. In another embodiment, the IDE process and separate process are connected to different nodes. In this other embodiment, the communications over the inter-process call channels can be over a Transmission Control Protocol (TCP) interface.

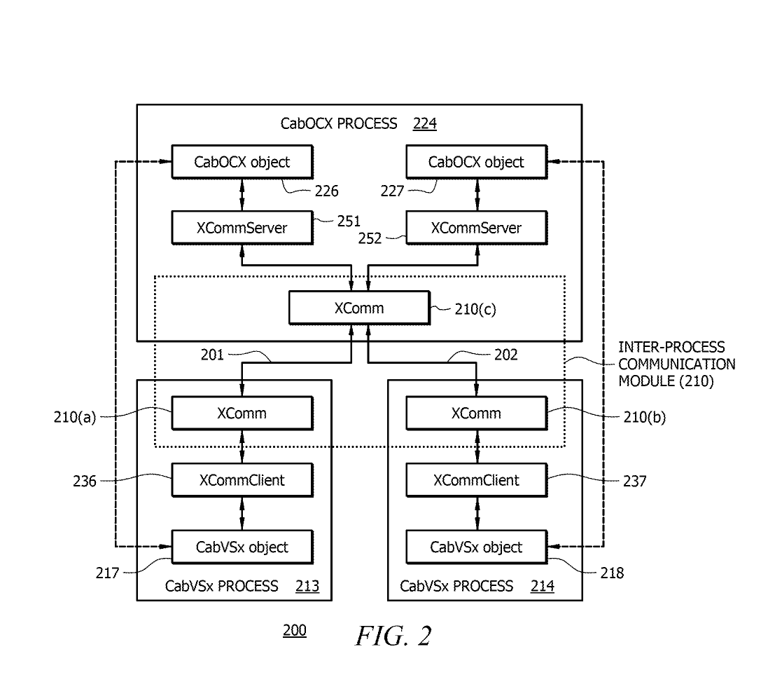

FIG. 2 illustrates a diagram of an exemplary system 200 including an inter-process communication module 210 shown as XComm 210 having a plurality of communication channels 201, 202 for passing events between IDE processes and a separate process, according to a disclosed embodiment. XComm 210 comprises XComm sub-modules 210 (a), 210(b), 210(c). The IDE processes are shown as CabVSx execution processes 213 and 214 and the separate process as CabOCX execution process 224 that represents the component that will receive commands from the calling CabVSx process 213 or 214. The CabOCX process 224 receives information from XComm 210 over inter-process communication channel 201 or 202 from the calling CabVSx process 213 or 214 for performing a requested operation, and then performs the requested operation. In FIG. 2, the dashed arrows represent this “logical method call” between the CabOCX process 224 and the CabVSx processes 213, 214.

There is one CabOCX process 224 for a given separate process (e.g., CONTROL BUILDER) node running the CAB edit sessions. The CabOCX is an ActiveX control that is running in the CabOCX process 224. There is one CabOCX object for each Cab VS session created. Each CabOCX object 226, 227 will work on behalf of a single Cab VS instance. There is one CabVSx process 213, 214 for each CAB edit session. Each Cab edit session can create one CAB VS instance and one CabVSx object 226, 227 for it.

The inter-process communication module identified in FIG. 2 as XComm 210 performs the low level communication between the respective processes 224 and 213, 214. The term “low level communication” represents the messaging protocol to actually transport the request/response messages between the respective processes (e.g. 224 and 213). The two processes will add the “information level” to the messaging (e.g., thru the content of the XML document) which is the intelligence part of the message that results in the desired behavior. As described above, the communications will generally use either IPC for connections for a single node arrangement or TCP for process connections between separate nodes. Communication on a single node over IPC generally uses less resources and has better performance than using TCP, but TCP is generally used if communicating between separate nodes.

The XCommServer handler module components 251, 252 shown in FIG. 2 implements the server side unique functions required by the CabOCX module “CabOCX object” 226, 227. The XCommClient handler module components 236, 237 implement the client side unique functions required by the CAB Visual Studio module “CabVSx object” 217, 218.

When a CabVSx module object 217, 218 calls the CabOCX process 224 to perform an operation, it can send a message by calling a method on the XCommClient module 236, 237. This message can be delivered to the CabOCX process 224 as an asynchronous method call, passing data. When the operation is completed by the CabOCX process 224, the CabOCX object 226, 227 can send a return message by calling a method on the XCommServer module 251, 252. This message will generally be delivered to the CABVSx process 213, 214 as an asynchronous method call, passing data in the messages for the particular message event.

The messages described above can be passed as XML data. XComm 210 adds a transport layer XML to the message sent by the CabVSx objects 217, 218 or CabOCX objects 226, 227. The format of the transport layer XML can use standard XML syntax but by adding the “CAB Message” in the CDATA section to allow the transport layer to move “events” between the respective processes. The content of the Cab Message (syntax shown in the Examples section below) provides information to the XComm sub-modules 210 (a), 210(b), 210(c) in XComm 210 as to what “events” are to be reported to the CabOCX process 224 and CabVSx processes 213, 214. The “routing” information in this transport layer allows the XComm sub-modules 210(a), 210(b), 210(c) in Inter-process Communication Module 210 to properly send messages between the appropriate OCX (e.g. CabOCX process 224) and IDE processes (e.g. CabVSx process 213 or 214) since there may be a plurality of OCX and IDE processes active at any given time.

### EXAMPLES

Disclosed embodiments are further illustrated by the following specific Examples, which should not be construed as limiting the scope or content of this Disclosure in any way.

As described above, the messages can be passed as XML data, with the inter-process communications module adding transport layer XML to the message sent by the CAB components. Shown below is an exemplary transport layer XML format.

<?xml version=“1.0” encoding=“utf-8”?>
<XCRemoteReq>

<XCRHeader>

<XCVersion>300</XCVersion>
<Count>1</Count>
<DateTime>2009/02/05 10:06:16.62067</DateTime>
<RequestID></RequestID>

</XCRHeader>
<XCRouting>

<XCReqType>5</XCReqType>
<XCReqPriority>1</XCReqPriority>
<XCReceiver>127.0.0.1:1517/CabVSClient_5956</XCReceiver>
<XCQueueTo>0</XCQueueTo>
<XCSender>5a24f7e2-c843-4366-ad1b-0da4b8280914</XCSender>

</XCRouting>
<XCCredentials>

<XCSessionID>ae7a91de-20c3-4cdd-86eb-7219d410d183</XCSessionID>

</XCCredentials>
<XCommConnectRequest><![CDATA[<CAB message>]]></XCommConnectRequest>

</XCRemoteReq>

As described above, the transport layer contains the routing and security session identifier information. The routing information is used to direct the message to the receiver module and to identify the sender for any return message.

The “<CAB message>” can be encapsulated inside the transport layer and can be of the following exemplary format:

<?xml version=“1.0” encoding=“utf-8”?>
<XCommConnectRequest>

<XCRHeader>

<XCVersion>300</XCVersion>
<RequestID>3f1eafd2-28cc-44ce-82f5-512aa8a7757a</RequestID>
<Count>1</Count>
<DateTime>2009/02/05 10:06:17.27691</DateTime>

</XCRHeader>
<XCStatus>

<XCStsHeader>

<XCVersion>300</XCVersion>

</XCStsHeader>
<Details>

<Detail>

<Sev>0</Sev>
<Text></Text>
<Src>0</Src>
<Code>0</Code>

</Detail>

</Details>

</XCStatus>
<XCMessage>

<XCMHeader>

<XCVersion>300</XCVersion>
<DateTime>2009/02/05 10:06:17.27691</DateTime>
<Type>1</Type>

</XCMHeader>
<XCStatus>

<XCStsHeader>

<XCVersion>300</XCVersion>

</XCStsHeader>
<Details>

<Detail>

<Sev>0</Sev>
<Text></Text>
<Src>0</Src>
<Code>0</Code>

</Detail>

</Details>

</XCStatus>
<XCMDetail />

</XCMessage>

</XCommConnectRequest>

The particular layout of the CAB message is generally determined by the requirements of the IDE module (e.g., CAB VS module) and the separate process module (e.g., CAB OCX module). Any layout is generally acceptable as long as it is well-formed. The transport layer will pass any message such as an XML message between the separate processes acting as a server and the IDE process acting as a client.

Although disclosed embodiments have been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In light of the forgoing description, it should be recognized that the subject matter in this Disclosure can be realized in hardware, software, or a combination of hardware and software. Any kind of computer system, or other apparatus adapted for carrying out the methods described herein, is generally suited. A typical combination of hardware and software could be a general purpose computer processor, with a computer program that, when being loaded and executed, controls the computer processor such that it carries out the methods described herein. Of course, an application specific integrated circuit (ASIC), and/or a field programmable gate array (FPGA) could also be used to achieve a similar result.

Disclosed embodiments can also be embedded in a computer program product, which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following: (a) conversion to another language, code or notation; (b) reproduction in a different material form. Additionally, the description above is intended by way of example only and is not intended to limit this Disclosure in any way, except as set forth in the following claims.

1. A method for inter-process communications between an integrated development environment (IDE) process and a separate process, comprising:
communicably coupling said IDE process and said separate process using an inter-process communication module implemented by program code run by a processor, wherein said inter-process communication module provides inter-process call channels for transporting messages between said IDE process and said separate process, and adds a transport layer comprising routing information to said messages;
performing an action by a caller that raises an event that includes a requested operation to said IDE process, wherein said requested operation is supported by said separate process but not by said IDE process, and wherein said event is caught by said IDE process;
sending a command message from said IDE process to said separate process using a first of said inter-process call channels, wherein said command message includes information for performing said requested operation;
performing said requested operation by said separate process, and
after completing said requested operation, sending a return message from said separate process using a second of said inter-process call channels to said IDE process.

2. The method of claim 1, wherein said separate process is a master controlling process.

3. The method of claim 1, wherein said command message and said return message comprise XML data and said transport layer comprises transport layer XML.

4. The method of claim 3, wherein said transport layer XML encapsulates an XML message layer, wherein a content of said XML message layer (i) moves events between said IDE process and said separate process, and (ii) transfers commands to be performed in said separate process for said command message.

5. The method of claim 4, wherein said commands and said events are encapsulated in a single XML document.

6. The method of claim 4, wherein said content provides information to said inter-process communication module as to which of said events are to be reported to said IDE process and said separate process.

7. The method of claim 1, wherein said IDE process comprises a VISUAL STUDIO process and said separate process comprises a Custom Algorithm Block (CAB)OCX process.

8. The method of claim 7, wherein said (CAB)OCX process is operable to create and manage at least one control strategy.

9. The method of claim 1, wherein said IDE process and said separate process are connected to a common node, and wherein communications over said inter-process call channels are over an Interprocess Communication (IPC) interface.

10. The method of claim 1, wherein said IDE process and said separate process are connected to different nodes, and wherein communications over said inter-process call channels are over a Transmission Control Protocol (TCP) interface.

11. The method of claim 1, wherein said command message and said return message both comprise asynchronous message calls.

12. A computer program product for inter-process communications between an integrated development environment (IDE) process and a separate process, comprising:
communicably coupling said IDE process and said separate process by an inter-process communication module implemented by a processor running program code that provides inter-process call channels, and adds a transport layer comprising routing information to messages sent over said inter-process call channels;
performing an action by a caller that raises an event that includes a requested operation to said IDE process, wherein said requested operation is supported by said separate process but not by said IDE process, and wherein said event is caught by said IDE process;
sending a command message from said IDE process to said separate process using a first of said inter-process call channels, wherein said command message includes information for performing said requested operation;
performing said requested operation by said separate process, and after completing said requested operation, sending a return message from said separate process using a second of said inter-process call channels to said IDE process.

13. The computer program product of claim 12, wherein said command message and said return messages comprise XML data and said transport layer comprises transport layer XML.

14. The computer program product of claim 12, wherein said transport layer XML encapsulates an XML message layer, wherein a content of said XML message layer moves events between said IDE process and said separate process, and transfers commands to be performed in said separate process for said command message.

15. The computer program product of claim 12, wherein said IDE process comprises a VISUAL STUDIO process and said separate process comprises a Custom Algorithm Block (CAB)OCX process.

16. The computer program product of claim 12, wherein said (CAB)OCX process is operable to create and manage at least one control strategy.
